(19) United States
(12) Patent Application Publication
(10) Pub. No.: US 2008/0107103 A1
(43) Pub. Date: May 8, 2008

(54) Non-blocking multicast switching network

(76) Inventors: Yuanyuan Yang, East Setauket, NY (US); Takashi Oguma, Kawasaki-shi (JP)

Correspondence Address: DAY PITNEY LLP, 7 TIMES SQUARE, NEW YORK, NY, 10036-7311, US

(21) Appl. No.: 11/593,756

(22) Filed: Nov. 7, 2006

(51) Int. Cl. H04Q 11/00

(52) U.S. Cl. 370/388; 370/390

(57) ABSTRACT

A k-source N₁×N₂ nonblocking multicast switching network has N₁ input ports and N₂ output ports with each port having k independent channels, in which each input channel can perform a multicast connection, i.e. send data simultaneously to multiple output channels, without interrupting existing multicast connections from other input channels. We provide the construction and the routing algorithm of a multi-source nonblocking multicast three-stage switching network. A k-source N₁×N₂ such a switching network consists of three stages of switch modules (which are k-source multicast switching networks with smaller sizes). It has r₁ k-source n₁×m switch modules in the input stage, m k-source r₁×r₂ switch modules in the middle stage, and r₂ k-source m×n₂ switch modules in the output stage with N₁=n₁r₁ and N₂=n₂r₂. There are exactly k channels (corresponding to one port of k-source switch module) between every two switch modules in two consecutive stages. The nonblocking condition for the multicast network is

$$m > {min}_{1 \leq x \leq min \{ {n}_{2} - 1 , {r}_{2} \}} \{ ⌊ ( {n}_{1} - \frac{1}{k} ) x ⌋ + ( {n}_{2} - 1 ) {r}_{2}^{\frac{1}{x}} \}$$

A refining approach to further reduce the above m value by reducing m′ (which may start from

$$( {n}_{2} - 1 ) {r}_{2}^{\frac{1}{x}} )$$

for the chosen x in the above is also disclosed.

### BACKGROUND OF THE INVENTION

1. Field of the Invention

The present invention pertains to a nonblocking multicast switching network. More specifically, the present invention pertains to a multicast switching network having m middle stage switches where x or fewer of the m middle switches are always available to form a channel connection between an input port and an idle output ports.

2. Description of the Prior Art

Traditionally, an N₁×N₂ Clos multicast network consists of three stages of switch modules. It has r₁ switch modules of size n₁×m in the input stage, m switch modules of size r₁×r₂ in the middle stage, and r₂ switch modules of size m×n₂ in the output stage with N₁=n₁r₁, N₂=n₂r₂, and m≧max{n₁, n₂} as shown in FIG. 1. In such a network, there is exactly one link between every two switch modules in two consecutive stages, and each switch module is assumed to be multicast-capable.

Previous works such as Masson (G. M. Masson and B. W. Jordan, “Generalized multi-stage connection networks,” Networks, vol. 2, pp. 191-209, 1972.), Hwang (F. K. Hwang and A. Jajszczyk, “On nonblocking multiconnection networks,” IEEE Trans. Communications, vol. 34, pp. 1038-1041, 1986.), and Yang-Masson (Y. Yang and G. M. Masson, “Nonblocking broadcast switching networks,” IEEE Trans. Computers, vol. 40, no. 9, pp. 1005-1015, 1991.) have demonstrated that when m takes certain values, the three-stage Clos network has full multicast capability in a nonblocking manner.

Recently, as the new technology develops, more powerful switching elements are commercially available, see, for example, Fujitsu's AXEL-X MB8AA3020 10G Ethernet Switch (e.g. AXEL-X MB8AA3020 Chip Specification, Revision 2.0, Fujitsu Laboratories of America, March, 2006, and http://www.fujitsulabs.com/). In such a switch, each port of the switch can simultaneously support multiple data streams from independent sources. We call this type of switch multi-source switches. In general, an s×s multi-source multicast switch has s input ports and s output ports, and each port has k independent links. The switch can connect from any input link to any set of output links. We can simply call the switch an s×s k-source switch. The switch can function as an sk×sk ordinary multicast switch. In fact, the internal implementation of such a switch is packet switching. For example, letting k=5, an s×s multi-source switch with 10G bandwidth on each port is equivalent to an sk×sk ordinary switch with 2G bandwidth on each link.

### SUMMARY OF THE INVENTION

In this disclosure, a large nonblocking multicast switching network is constructed by using the above multi-source switching elements in the three-stage Clos type network.

The new N₁×N₂ multicast network has N₁ input ports and N₂ output ports with each port having k links. We call this multistage network k-source N₁×N₂ multistage network. Compared to the ordinary Clos type network, the major difference is that in the k-source multistage switching network there are k links between every two switch modules in two consecutive stages as shown in FIG. 2. The aim of the following disclosure are to show what the nonblocking condition for this type of network is; how to optimize the design of such a three-stage network in terms of the number of multi-source switching elements (instead of the traditional cost metric, the number of crosspoints); and how to design the routing algorithm to add/delete a connection to/from an existing multicast connection tree without packet loss.

### BRIEF DESCRIPTION OF THE DRAWINGS

FIG. 1 shows a three-stage switching network of the prior art.

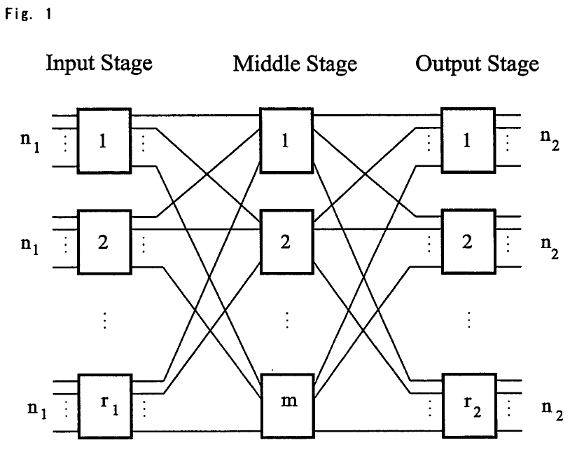

FIG. 2 shows a three-stage multi-source switching network of the current disclosure.

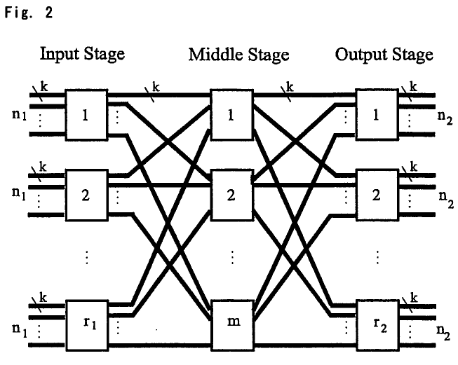

FIG. 3 shows a refining algorithm of the number of available middle stage switches.

FIG. 4 shows a sketch of adding a new multicast branch to an existing multicast tree in different cases.

FIG. 5 shows a illustration of two overlapped multicast trees for multicast connection request.

FIG. 6 shows another example of two overlapped multicast trees for connection requests.

FIG. 7 shows a routing algorithm of the current disclosure.

### DESCRIPTION OF THE PREFERRED EMBODIMENT

The key issue of obtaining nonblocking conditions for such a network is to determine the minimum number of switches in the middle stage.

For simplicity, we first consider the symmetric network, that is, N₁=N₂=N, n₁=n₂=n, and r₁=r₂=r, and then extend to the general case.

Recall that in the ordinary Clos type multicast network, we defined the destination set of a middle stage switch as the set of labels of output stage switches that are connected from this middle stage switch. However, in the case of the k-source Clos type multicast network, a middle stage switch can have up to k connections to an output stage switch. Thus, we must consider destination multiset with elements that may have a multiplicity larger than 1 as defined in following notations.

Let O={1, 2, . . . , r} denote the set of labels of all output stage switches numbered from 1 to r. Since there can be up to k multicast connections from a middle stage switch jε{1, 2, . . . , m} to an output stage switch pεO, one on each link, we shall use Mⱼ to represent the destination multiset (whose base set is O), where p may appear more than once if more than one multicast connections are from j to p. The number of times p appears in Mⱼ, or the number of multicast connections from j to p, is called the multiplicity of p in multiset Mⱼ.

More specifically, denote the multiset Mⱼ as

$${M}_{j} = \{ {1}^{{i}_{{j}_{1}}} , {2}^{{i}_{{j}_{2}}} , … , {r}^{{i}_{{j}_{r}}} \} , \qquad ( 1 )$$

where 0≦iⱼ_{₁}, iⱼ_{₂}, . . . , iⱼ_{ᵣ}≦k are the multiplicities of elements 1, 2, . . . , r, respectively. Notice that if every multiplicity is less than k, i.e. 0≦iⱼ_{₁}, iⱼ_{₂}, . . . , iⱼ_{ᵣ}≦k−1, then the maximal multicast connection that can be realized through middle stage switch j without interfering any existing connections is {1, 2, . . . , r} (in terms of the set of output stage, switches reachable from middle stage switch j). In general, the maximal multicast connection that can go through middle stage switch j is {p|0≦iⱼ_{ₚ}<k for 1≦p≦r}. Now the question is: What is the maximal multicast connection that can go through two middle stage switches j and h? We thus define the intersection of multisets as follows.

$${M}_{j} ⋂ {M}_{h} = \{ {1}^{min \{ {i}_{{j}_{1}} , {i}_{{h}_{1}} \}} , {2}^{min \{ {i}_{{j}_{2}} , {i}_{{h}_{2}} \}} , … , {r}^{min \{ {i}_{{j}_{r}} , {i}_{{h}_{r}} \}} \} \qquad ( 2 )$$

### Then the maximal multicast connection that can go through two middle stage switches j and h is the maximal multicast connection that can go through a middle stage switch with its destination multiset equal to multiset Mⱼ∩Mₕ.

From the point of realizing a multicast connection, which is characterized as an ordinary set, we can see that those elements in Mⱼ with multiplicity k cannot be used. Accordingly, we define the cardinality of Mⱼ as

|Mⱼ|=|{p|p^{k}εMⱼ for 1≦p≦r}| (3)

and the null of Mⱼ as

Mⱼ=φiff|Mⱼ|=0. (4)

It can be verified that a lemma proved by Yang-Masson (Y. Yang and G. M. Masson, “Nonblocking broadcast switching networks,” IEEE Trans. Computers, vol. no. 9, pp. 1005-1015, 1991.) still holds when we consider Mⱼ as a multiset and use the definitions of intersection, cardinality and null of multisets in (2)-(4).

The lemma proved by Yang-Masson, which we call “Lemma 1” in this disclosure, is as follows:

Lemma1:

A new multicast connection request with fanout r can be satisfied using some x (x≧1) middle stage switches, say, i₁, . . . , iₓ, from among the available middle switches if and only if the intersection of the destination sets of these x middle stage switches is empty, i.e. ∩ⱼ₌₁^{x}Mₖ_{ⱼ}=φ.

Now we are in the position to extend the results of nonblocking conditions for an ordinary multicast network in Yang-Masson to that for a k-source multicast network, i.e. the destination multiset being a multiset with multiplicity no more than k as defined in (1), and their operations are defined in (2)-(4).

Theorem 1:

For any x, 1≦x≦min{n−1,r}, let m′ be the maximum number of middle stage switches whose destination multisets satisfy that their multiplicities are no more than k, that there are at most (nk−1) 1's, (nk−1) 2's, . . . , (nk−1) r's distributed among the m′ destination multisets, and that the intersection of any x of the destination multisets is not empty. Then we have

$${m}^{′} \leq ( n - 1 ) {r}^{\frac{1}{x}}$$

The Proof of Theorem 1 is as follows. Suppose these m′ middle switches are 1, 2, . . . , m′ with destination multisets M₁, M₂, . . . , M_{m′}, which are nonempty multisets by the assumptions. Clearly, by using (3) and (4) we have that

0<|Mᵢ|≦r for 1≦i≦m′

Notice that at most (nk−1) 1's, (nk−1) 2's, . . . , (nk−1) r's are distributed among the m′ multisets. Moreover, from (3), k multiple of the same element in Mᵢ contributes a value 1 to |Mᵢ|. Thus, for any j (1≦j≦r), (nk−1) multiple of element j contributes a value no more than

$$⌊ \frac{nk - 1}{k} ⌋$$

to

$${\sum }_{i = 1}^{{m}^{′}} \vert {M}_{i} \vert .$$

have

$${\sum }_{i = 1}^{{m}^{′}} \vert {M}_{i} \vert \leq ⌊ \frac{nk - 1}{k} ⌋ r = ⌊ n - \frac{1}{k} ⌋ r = ( n - 1 ) r$$

Let Mⱼ_{₁} be the multiset such that

$$\vert {M}_{j 1} \vert = {min}_{1 \leq i \leq {m}^{′}} \vert {M}_{i} \vert$$

Then, we obtain that

$${m}^{′} \vert {M}_{j 1} \vert \leq {\sum }_{i = 1}^{{m}^{′}} \vert {M}_{i} \vert \leq ( n - 1 ) r ,$$

and thus

$${m}^{′} \leq \frac{( n - 1 ) r}{\vert {M}_{j 1} \vert} \qquad ( 5 )$$

by noting that |Mⱼ_{₁}|>0.

Without loss of generality, suppose that in multiset Mⱼ_{₁}, the |Mⱼ_{₁}| elements each with multiplicity k are 1, 2, . . . , |Mⱼ_{₁}|. Now, consider m′ new multisets Mⱼ_{₁}∩Mᵢ for 1≦i≦m′. From (2), (3) and the assumption that the intersection of any two multisets is nonempty, we have and only elements 1, 2, . . . , |Mⱼ_{₁}| in multiset Mⱼ_{₁}∩Mᵢ may have multiplicity k, thus can make a contribution to the value of |Mⱼ_{₁}∩Mᵢ|. Notice that at most (nk−1) 1's, (nk−1) 2's, . . . , (nk−1) |Mⱼ_{₁}|'s are distributed in the m′ multisets Mⱼ_{₁}∩M₁ for 1≦i≦m′. Again, by using a similar analysis as above, we obtain that

$${\sum }_{i = 1}^{{m}^{′}} \vert {M}_{j 1} ⋂ {M}_{i} \vert \leq ⌊ \frac{nk - 1}{k} ⌋ \vert {M}_{j 1} \vert = ( n - 1 ) \vert {M}_{j 1} \vert \qquad ( 6 )$$

### Let Mⱼ_{₂} be the multiset such that

$$\vert {M}_{j 1} ⋂ {M}_{j 2} \vert = {min}_{1 \leq i \leq {m}^{′}} \vert {M}_{j 1} ⋂ {M}_{i} \vert$$

### Then, we can similarly obtain

$${m}^{′} \leq \frac{( n - 1 ) \vert {M}_{j 1} \vert}{\vert {M}_{j 1} ⋂ {M}_{j 2} \vert} \qquad ( 7 )$$

by noting that |Mⱼ_{₁}∩Mⱼ_{₂}|>0.

In general, for 2≦y<x, we have

$${m}^{′} \leq \frac{( n - 1 ) \vert {⋂}_{l = 1}^{y - 1} {M}_{j 1} \vert}{\vert {⋂}_{l = 1}^{y} {M}_{j 1} \vert} \qquad ( 8 )$$

and |∩ₗ₌₁^{y}Mⱼ_{ₗ}|>0 based on the assumption that the intersection of no more than x original multisets is nonempty.

On the other hand, also based on this assumption, we have m′ multisets (∩ₗ₌₁^{x-1}Mⱼ_{₁})∩Mᵢ (1≦i≦m′) which are all nonempty. This means that |(∩ₗ₌₁^{x-1}Mⱼ_{ₗ})∩Mᵢ|≧1 for 1≦i≦m′, and

$${m}^{′} \leq {\sum }_{i = 1}^{{m}^{′}} \vert ( {{⋂}^{x - 1}}_{l = 1} {M}_{ji} ) ⋂ {M}_{i} \vert .$$

### Then, by using a similar argument as that in deriving (6), we can establish

$${m}^{′} \leq ( n - 1 ) \vert {{⋂}_{l = 1} {M}_{{j}_{l}}}^{x - 1} \vert \qquad ( 9 )$$

Finally, m′ must be no more than the geometric mean of the right hand sides of (5), (8), and (9), and thus we obtain

$${m}^{′} \leq ( n - 1 ) {r}^{\frac{1}{x}}$$

Q.E.D.

The immediate corollary of Theorem 1 is as follows.

### Corollary 1:

In a Clos type k-source multicast network, for a new multicast connection request with fanout r′, 1≦r′≦r, if there exist more than

$$( n - 1 ) {r}^{′ \frac{1}{x}} ,$$

1≦x≦min{n−1, r′}, available middle switches for this connection request, then there will always exist x middle stage switches through which this new connection request can be satisfied.

Accordingly, we can establish nonblocking conditions for the k-source multicast network as follows.

Theorem 2:

### A Clos type k-source N×N multicast network is nonblocking for any multicast assignments if

$$m > {min}_{1 \leq x \leq min \{ n - 1 , r \}} \{ ⌊ ( n - \frac{1}{k} ) x ⌋ + ( n - 1 ) {r}^{\frac{1}{x}} \} \qquad ( 10 )$$

The Proof of Theorem 2 is as follows. Recall that the routing strategy for realizing multicast connections is to realize each multicast connection by using no more than x middle stage switches. By Corollary 1, if we have more than

$$( n - 1 ) {r}^{\frac{1}{x}}$$

available middle switches for a new multicast connection request, we can always choose x middle stage switches to realize this connection request. Now there may be at most nk−1 other input links each of which is used for a multicast connection. By the routing strategy, each of them is connected to no more than x links on different outputs of this input stage switch and then connected to no more than x middle stage switches. Notice that unlike a traditional network, in a multi-source multicast network, two links at different input ports can be connected to two links of the same output of an input stage switch and then connected to the same middle stage switch. Now the question is: What is the number of middle stage switches which are not available for a new multicast connection in the worst case? Since each port has k links, if all the k links of the port connecting the current input stage switch to a middle stage switch are used by k existing multicast connections, this middle stage switch is not available. Therefore, we can have at most

$$⌊ \frac{( nk - 1 ) x}{k} ⌋ = ⌊ ( n - \frac{1}{k} ) x ⌋$$

middle stage switches which are not available for a new multicast connection request. Thus, the total number of middle stage switches required, m, is greater than the number of unavailable middle switches in the worst case plus the maximum number of available middle switches needed to realize a multicast connection. The minimum value for m is obtained from (10) by minimizing the right hand side expression for all possible values of x. Q.E.D.

The result for the more general network is Theorem 3 as shown below:

A Clos type k-source N₁×N₂ multicast network is nonblocking for any multicast assignments if

$$m > {min}_{1 \leq x \leq min \{ {n}_{2} - 1 , {r}_{2} \}} \{ ⌊ ( {n}_{1} - \frac{1}{k} ) x ⌋ + ( {n}_{2} - 1 ) {r}_{2}^{\frac{1}{x}} \} \qquad ( 11 )$$

A description is now made on the design further refined for the nonblocking multi-source multicast network. In the previous description, we have performed the initial analysis and obtained tentative designs for multi-source nonblocking multicast switching networks. Notice that the theoretical bound in Theorems 1, 2, and 3 are based on the optimization on real functions, which provides an asymptotic closed form bound for the number of available middle stage switches. When considering the fact that the cardinality of each destination multiset is an integer, we can have the following refinement, which further reduces the network cost.

For a given k-source multicast network with parameters

N=160, n=8, r=20, k=5,

by using Theorem 2 we can calculate

x=3, m=43,

and the bound on the number of available middle switches is

$${m}^{′} = ⌈ ( {n}^{′} - 1 ) {r}^{\frac{1}{x}} ⌉ = ⌈ 7 * {20}^{\frac{1}{3}} ⌉ = ⌈ 19.000923 … ⌉ = 20$$

We first verify that any new multicast connection request can be realized by using x (=3) middle stage switches among given m′=20 available middle stage switches.

According to (5), the first chosen middle stage switch j₁ satisfies

$$\vert {M}_{{j}_{1}} \vert \leq ⌊ \frac{( n - 1 ) r}{{m}^{′}} ⌋ = ⌊ \frac{7 * 20}{20} ⌋ = 7 ;$$

according to (7), the second chosen middle stage switch j₂ satisfies

$$\vert {M}_{{j}_{1}} ⋂ {M}_{{j}_{2}} \vert \leq ⌊ \frac{( n - 1 ) \vert {M}_{{j}_{1}} \vert}{{m}^{′}} ⌋ \leq ⌊ \frac{7 * 7}{20} ⌋ = ⌊ 2.45 ⌋ = 2 ;$$

and finally, the third chosen middle stage switch j₃ satisfies

$$\vert {M}_{{j}_{1}} ⋂ {M}_{{j}_{2}} ⋂ {M}_{{j}_{3}} \vert \leq ⌊ \frac{( n - 1 ) \vert {M}_{{j}_{1}} ⋂ {M}_{{j}_{2}} \vert}{{m}^{′}} ⌋ \leq ⌊ \frac{7 * 2}{20} ⌋ = ⌊ 0.7 ⌋ = 0.$$

### Thus, we have Mⱼ_{₁}∩Mⱼ_{₂}∩Mⱼ_{₃}=φ. That is, any multicast connection request can be realized by the three middle stage switches j₁, j₂ and j₃ chosen from m′=20 available middle stage switches.

Since the bound calculated for m′ in the last section is based on real functions, the actual bound may be slightly smaller. In this specific case, it can be verified that m′=18 instead of m′=20 is the smallest m′ which guarantees that any new multicast connection request can be realized by at most x (=3) middle stage switches. The justification is given below.

For the first chosen middle stage switch j₁,

$$\vert {M}_{{j}_{1}} \vert \leq ⌊ \frac{( n - 1 ) r}{{m}^{′}} ⌋ = ⌊ \frac{7 * 20}{18} ⌋ = ⌊ 7.777 … ⌋ = 7 ;$$

for the second chosen middle stage switch j₂,

$$\vert {M}_{{j}_{1}} ⋂ {M}_{{j}_{2}} \vert \leq ⌊ \frac{( n - 1 ) \vert {M}_{{j}_{1}} \vert}{{m}^{′}} ⌋ \leq ⌊ \frac{7 * 7}{18} ⌋ = ⌊ 2.722 … ⌋ = 2 ;$$

and for the third chosen middle stage switch j₃,

$$\vert {M}_{{j}_{1}} ⋂ {M}_{{j}_{2}} ⋂ {M}_{{j}_{3}} \vert \leq ⌊ \frac{( n - 1 ) \vert {M}_{{j}_{1}} ⋂ {M}_{{j}_{2}} \vert}{{m}^{′}} ⌋ \leq ⌊ \frac{7 * 2}{18} ⌋ = ⌊ 0.777 … ⌋ = 0.$$

### Thus, x (=3) middle stage switches are sufficient to realize any multicast connection for m′=18.

On the other hand, to see m′=18 is the smallest, we show that it is impossible to realize any multicast connection when m′=17.

For the first chosen middle stage switch j₁,

$$\vert {M}_{{j}_{1}} \vert \leq ⌊ \frac{( n - 1 ) r}{{m}^{′}} ⌋ = ⌊ \frac{7 * 20}{17} ⌋ = ⌊ 8.235 … ⌋ = 8 ;$$

for the second chosen middle stage switch j₂,

$$\vert {M}_{{j}_{1}} ⋂ {M}_{{j}_{2}} \vert \leq ⌊ \frac{( n - 1 ) \vert {M}_{{j}_{1}} \vert}{{m}^{′}} ⌋ \leq ⌊ \frac{7 * 8}{17} ⌋ = ⌊ 3.294 … ⌋ = 3 ;$$

and for the third chosen middle stage switch j₃,

$$\begin{matrix}\vert {M}_{j 1} ⋂ {M}_{j 2} ⋂ {M}_{j 3} \vert \leq ⌊ \frac{( n - 1 ) \vert {M}_{j 1} ⋂ {M}_{j 2} \vert}{{m}^{′}} ⌋ \\ \leq ⌊ \frac{7 * 3}{17} ⌋ \\ = ⌊ 1.235 … ⌋ \\ = 1.\end{matrix}$$

### We can see that we may have the case that Mⱼ_{₁}∩Mⱼ_{₂}∩Mⱼ_{₃}≠φ; that is, x (=3) middle stage switches may not be sufficient to realize all possible multicast connections.

Therefore, we have proved that m′=18 is the smallest. Thus, the configuration can be refined to

n=8, r=20, N=160, k=5, x=3 and m=41

Notice that the bounds on the minimum cardinalities of the intersected destination multisets in x (=3) steps for the minimum m′=18 are

c₁=7, c₂=2 and c₃=0

### In general, let the bounds on the minimum cardinalities of the intersected destination multisets in x steps for the minimum m′ be

c₁, c₂, . . . , cₓ. (12)

### It is worth pointing out that (12) will be used as system parameters in the routing algorithm later.

A description is now made on the refining algorithm for the number of available middle stage switches.

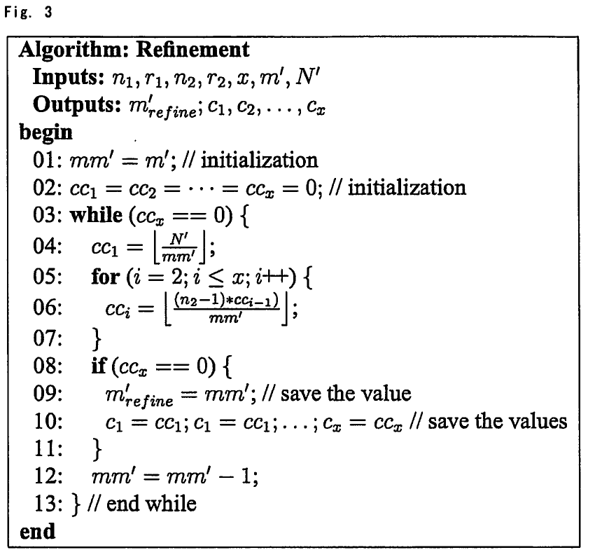

FIG. 3 presents the refining algorithm for an N₁×N₂ network. It takes inputs as the network parameters n₁, r₁, n₂, r₂, the chosen x, an initial m′ value (e.g. it can be chosen as

$$( {n}_{2} - 1 ) {r}_{2}^{\frac{1}{x}} )$$

and N′ that is the maximum number of elements distributed in middle stage switches (e.g. (n₂−1)r₂) as shown in FIG. 3. The outputs of the algorithm are the refined m′_{refine} and the system parameters in (12).

Finally, the refined m is

$$m = ⌊ ( {n}_{1} - \frac{1}{k} ) x ⌋ + {m}_{refine}^{′} .$$

according to Theorem 3.

Notice that the refining approach is suitable for k-source three-stage multicast networks for any k≧1 that includes the ordinary multicast networks when k=1.

In what follows, a high level description of a routing algorithm for adding and deleting a multicast connection is made.

In the following, we present the routing algorithm for multi-source nonblocking multicast switching networks. Compared to the single-source multicast routing algorithm, the main challenges and differences are that we are considering adding and deleting a single multicast branch to/from an existing multicast tree, and we need to deal with the situation that two adjacent switch modules have multiple interstage links.

Before we present the routing algorithm, we give some related terminologies. Notice that all entities described in the following are in terms of the logical layout of the switching network, not the physical layout. Therefore, we simply refer to a switch module as a switch.

A channel (or a link) in a three-stage multi-source multicast switching network can be described as a 5-tuple

<Stage, InOut, Switch#, Port#, Channel#> (13)

where Stage takes one of the values in set {IN, MID, OUT} representing which stage is referred to; InOut takes one of the values in set {IN, OUT} representing which side of the switch this channel is in; Switch# is the switch number in the stage; Port# is the port number in the switch; and Channel# is the channel number (between 0 and k−1) in the port.

For simplicity, we may refer to an input channel of the network as

<Switch#, Port#, Channel#>,

which is in fact

<IN, IN, Switch#, Port#, Channel#>;

and similarly an output channel

<Switch#, Port#, Channel#>

actually means <OUT, OUT, Switch#, Port#, Channel#>.

A multicast address is defined as a set of output channels

{OutputChannel₁, OutputChannel₂, . . . , OutputChannel_{f}}; (14)

however, sometimes we may only be interested in the switches in the output stage, thus a multicast address can also be expressed in terms of output stage switch labels

McastAddress⊂{0, 1, . . . , r₂−1} (15)

A multicast connection request is defined as a pair of an input channel and a multicast address as

<InputChannel, MulticastAddress > (16)

Multicast routing for a given multicast connection request is to build a multicast tree by setting up connections on some selected switches, which are consist of one input stage switch that the input channel is in, some selected middle stage switches, and all the output stage switches involved in the multicast address.

The switch setting inside a switch is typically a one-to-many connection from a channel of an input port to a set of channels of different output ports in this switch. For some output stage switch, more than one channels may be in the same output port, as required by a particular multicast connection request. For a one-to-many connection in the switch, we call the input channel of the switch local input channel, and the set of output channels of the switch local multicast address. A one-to-many connection in a switch as part of the multicast tree is denoted as

LocalInputChannel→LocalMulticastAddress (17)

### In addition, the fixed interstage connections in a multi-source Clos type multistage network enforce some channels between switches of the adjacent stages to be connected (or, equivalent.) In fact, we have

<IN, OUT, w₁, p, channel#>==<MID, IN, p, w₁, channel#>

<MID, OUT, p, w₂, channel#>==<OUT, IN, w, p, channel#>

where 0≦w₁≦r₁−1, 0≦w₂≦r₂−1, and 0≦p≦m−1

Thus, the multicast connection request can be realized in the switching network by a multicast tree constructed by a set of one-to-many connections as shown in (17) in selected switches and the fixed interstage linkages as shown in (18). Clearly, among the selected middle stage switches, no two of them lead to the same output switch in the multicast tree.

Notice that any connection in a multicast tree cannot share a channel with other multicast trees in any switch so that there is no conflict among different multicast trees.

For convenience, the local multicast address of a one-to-many connection (17) in an input stage switch can also expressed as a set of middle stage switch labels

InLocMcastAddr⊂{0, 1, . . . , m−1}; (18)

and the local multicast address in a middle stage switch can also be expressed as a set of output stage switch labels as

MidLocMcastAddr⊂{0, 1, . . . , r₂−1} (19)

The destination multiset for a middle stage switch defined in the previous section

$${M}_{j} = \{ {0}^{{j}_{0}} , {1}^{{j}_{1}} , … , {( {r}_{2} - 1 )}^{{j}_{{r}_{2} - 1}} \} \qquad ( 20 )$$

is still useful in describing the routing algorithm. Also, for describing adding and deleting a connection in a middle stage switch, we define the operations of “+” and “−” of a multiset Mj and an ordinary set V based on set {0, 1, . . . , r−1} as

$${M}_{j} \pm V = \{ {0}^{{j}_{0} \pm {v}_{0}} , {1}^{{j}_{1} \pm {v}_{1}} , … , {( {r}_{2} - 1 )}^{{j}_{{r}_{2} - 1} \pm {v}_{{r}_{2} - 1}} \} \qquad ( 21 )$$

where vᵢ=1 if iεV; vᵢ=0 otherwise, for 0≦i≦r₂−1.

The resulting multiset of (21) becomes illegal if there is some multiplicity being <0 or >k, which is due to an illegal V being used.

In the following, a description on a routing algorithm for adding and deletion of routes in a multi-source network is made.

Recall that the nonblocking routing strategy for Clos type multicast networks is to allow each multicast tree to use at most x (a pre-determined value) middle stage switches.

In general, there are two types of multicast connection requests, input-based multicast routing and output-based multicast routing. An input-based multicast connection request is to build a new multicast tree from an input link of the network. When requesting to delete the multicast connection, we drop the entire tree rooted at the input link. The routing algorithm in Yang-Masson can be used to serve this purpose.

In output-based multicast routing, when requesting to add, we add a branch from an output link to the existing multicast tree; when requesting to delete, we remove a branch attached to an output link of the network from the multicast tree.

Clearly, the deletion operation does not violate the nonblocking routing strategy since the number of middle stage switches for the multicast tree could not increase. Therefore, for the deletion operation in a multi-source network, we can simply delete the tree branch from the output channel towards the input side of the network until reaching a tree node that has another branch towards other output channels.

In the rest of the disclosure, we focus on the add operation. As will be seen in the following routing algorithm sketch, since each time we only add one branch, we have a good chance not to violate the nonblocking routing strategy, and can make a simple connection in most cases.

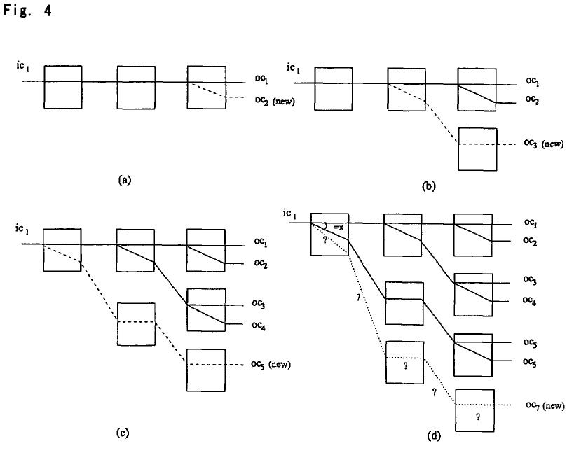

FIG. 4 shows a sketch of adding a new multicast branch (dashed line) to an existing multicast tree (solid lines) in different cases: (a) The new output channel is in one of the existing output stage switches on the tree; (b) The output stage switch that the new output channel is in is reachable from an idle channel in an output port of one of the existing middle stage switches; (c) The existing multicast tree has used less than predefined x middle stage switches; (d) The number of occupied middle stage switches already reaches x (non-trivial case).

The routing algorithm can be outlined by handling the cases in the following order.

Case 1: If the new output channel is in one of the existing output stage switches of the tree, then we simply make a connection in this output stage switch from the channel of the input port of the switch in the multicast tree to this output channel; then we are done (see the example in FIG. 4(a));

Case 2: If the output stage switch that the new output channel is in is reachable from an idle channel in an output port of one of the existing middle stage switches, then we make a connection in this middle stage switch so that the multicast tree is expanded to that idle channel; since the tree expands via an interstage link from this channel of the middle stage switch to the output stage switch, we finally make a connection in the output stage switch as in Case 1; then we are done (see the example in FIG. 4 (b));

Case 3: If the existing multicast tree has used less than x (a predefined value) middle stage switches, we can select an available middle stage switch that has an idle output port channel leading to (via an interstage link) this output stage switch (such a middle stage switch must exist since

$${m}^{′} = ( {n}_{2} - 1 ) {r}_{2}^{\frac{1}{x}} \geq {n}_{2} ) ,$$

then we make a connection in the input stage switch to extend the tree to the chosen middle stage switch, and finally make a connection from the middle stage switch to the new output channel as in Case 2; then we are done (see the example in FIG. 4 (c));

Case 4: The number of occupied middle stage switches in the existing multicast tree has already reached x. This is a non-trivial case and will be discussed in the next subsection.

In the following, a description on routing algorithm for the non-trivial case is made.

As described above, in the worst case that the existing multicast tree has already used x middle stage switches, we do need to change the existing multicast tree so that we can ensure that at most x middle stage switches are used. Fortunately, we can make non-interruptive changes such that no conflicting data are sent and no packets are lost.

In what follows a description on the properties of overlapped multi-source multicast trees is made

Let's consider two multicast trees that have the same input channel as their root and at least partially overlapped multicast addresses. The second tree is independently determined as if the first tree were released, however, we assume that the two trees are co-existing in the network at this moment. Thus, besides the overlapped branches, the two trees may have conflicts at some channels. In particular, two types of channel merges (“conflicts”) are possible. When two channels (as two branches of the two trees) on the same input port of a switch merge to a channel of an output port of this switch, we call it a branch merge at channel level. When two channels (as two branches of the two trees) on two different input ports of a switch merge to a channel of an output port of this switch, we call it a branch merge at switch level. The following theorem describes all possible overlapping cases for these two independently determined multicast trees with the same root.

Theorem 4:

In a Clos type three stage multi-source multicast network satisfying the nonblocking condition in Theorem 2 or 3, for the two independently determined multicast trees from the same input channel to two overlapped multicast addresses, they do not overlap with multicast trees rooted at other input channels of the switch. On the other hand, the two trees may share some tree branches (i.e., the connections in a switch) in the input stage switch, middle stage switches, and/or output stage switches; the two trees may have a branch merge at channel level in middle stage switches and/or output stage switches, and may have a branch merge at switch level in output stage switches.

The proof of Theorem 4 is as follows. Since each of the two multicast trees rooted at the same input channel is determined by at most x middle stage switches from

$${m}^{′} = m - ⌊ ( {n}_{1} - \frac{1}{k} ) x ⌋$$

available middle stage switches, by Theorem 2 or 3, each of them does not have any conflict with other (at most) n₁k−1 multicast trees rooted at other different input channels of the switch.

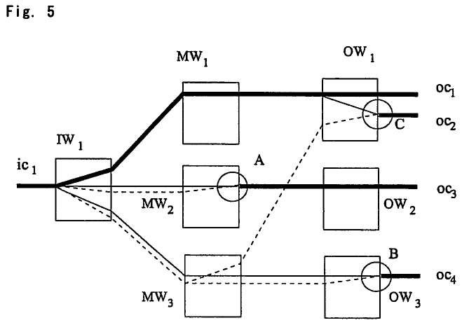

On the other hand, consider paths starting from the same input channel towards some common output channels of the network in the two trees. The two trees may share tree branches (i.e., the connections in a switch) in the input stage switch, middle stage switches, and/or output stage switches. In the connections of the input stage switch, since there is only one input channel for the two trees, it is impossible for two channels (as two branches of the two trees) of the input port to merge to a channel of an output port of this input stage switch. However, such a branch merge at channel level may occur at some middle stage switches and/or output stage switches shared by both multicast trees. Also, in the connections of a middle stage switch, since the tree branches of the two trees come from the same input stage switch, it is impossible for two channels of two different input ports of this middle stage switch (as two branches of the two trees) that come from two input stage switches merge to a channel of this middle stage switch. Such a branch merge at switch level is also impossible for the input stage switch. However, it is possible for some output stage switches. See FIG. 5 for examples of various cases. FIG. 5 is an illustration of two overlapped multicast trees for multicast connection request <ic₁, {oc₁, oc₂, oc₃, oc₄}>: light solid lines are tree branches only for the first multicast tree, the dashed lines are only for the second multicast tree, and heavy solid lines are shared tree branches, e.g. those from ic₁ to oc₁. Also, “A” and “B” are the points of the branch merge at channel level in the middle stage switch and the output stage switch, respectively; “C” is the point of the branch merge at switch level. Q.E.D.

We now applying Theorem 4 to the case that given an existing multicast tree for multicast connection <InChannel, McastAddr₁> in the network, add a new multicast connection branch with output channel oc_{new}, to the multicast address so that the new multicast address becomes McastAddr₂=McastAddr₁∪{oc_{new}}. Clearly, according to the nonblocking condition in Theorem 2 or 3, the new multicast tree can be constructed by ignoring the existing multicast tree with the same input channel as the root. That is, the new multicast tree will never conflict with any other existing multicast trees with different roots. Clearly, the newly built tree may have some “conflicts” with the existing tree with the same root as detailed in Theorem 4. This type of “conflicts” essentially would not cause data loss or mixed up as the existing tree and the new multicast tree are sending the same data.

In circuit switching, when given the circuit with merging capability, we can first add the new connection paths momentarily (by Theorem 2 or 3, m′ available middle stage switches can hold two x-sets of middle stage switches (may have some overlaps) for the two multicast trees) to provide non-interruptive data transmission, and then release the old multicast tree. Finally, the new multicast tree that realizes the new multicast connection request using at most x middle stage switches can guarantee the nonblocking condition for future multicast requests in the network.

In packet switching as in this project, a proper setting for the routing table in each switch can do the similar job effectively, and we will elaborate it in more detail in the next section;

Theoretically, the basic routing algorithm in Yang-Masson can be used here. However, for the operation of adding a multicast branch to an existing multicast tree, we prefer to keep original connections unchanged as much as possible. We now analyze all different cases described in Theorem 4 to see how we can meet this goal. Clearly, in the case of the two trees sharing some branches, we can keep the original setting of the existing tree for these branches. In the case of a branch merge at channel level, we still can use the original setting (as shown in the path from ic₁ to A and the path from ic₁ to B in FIG. 5), because the original setting and the new setting lead to the same switch in the next stage. However, in the case of a branch merge at switch level, we have to exchange the branches between the existing tree and the new tree.

The key step of multicast routing is to select up to x middle stage switches, which can be reached from the input channel and can connect to the output stage switches of the multicast address. In the following, we will develop a routing algorithm to generate a new multicast tree that utilizes branches from the existing multicast tree as much as possible, and keeps branch merges at switch level as few as possible. We first explore some useful properties to achieve these goals.

For a given network, we have system parameters c₁, c₂, . . . , cₓ as the bounds on the minimum cardinalities of the chosen intersected destination multisets for at most x selection steps, respectively. An example of such bounds is shown in (12). Based on the previous description on the design further fined for the nonblocking multi-source multicast network, in step i, any middle stage switch whose intersection with i−1 previously selected middle stage switches has a cardinality no more than cᵢ can be selected. Note that we do not need to select the middle stage switch with the minimum cardinality. This gives us more choices than the algorithm in Yang-Masson. In this case, among the candidates of such middle stage switches, we prefer to select a middle stage switch that is already in the existing multicast tree with the same root so that we can utilize the existing settings in the switch to achieve our first goal.

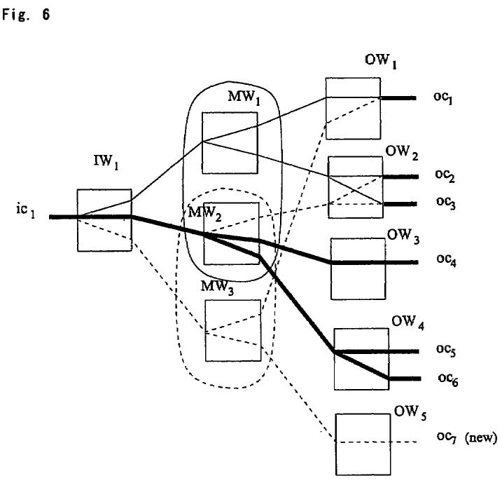

Another benefit of selecting the middle stage switch shared with the existing tree is to reduce the branch merge at switch level, which is our second goal. FIG. 6 is another example of two overlapped multicast trees for connection requests <ic₁, {oc₁, oc₂, . . . , oc₆}>, and <ic₁, {oc₁, oc₂, . . . , oc₆, oc₇}>: light solid lines are only for the first multicast tree, the dashed lines are only for the second multicast tree, and heavy solid lines are share tree branches. That is, in FIG. 6, if we first choose middle stage switch MW₁, the existing branch can cover both oc₁ and oc₂ in output stage switch OW₁, then when we choose middle switch MW₃ later, it does not need to cover OW₁ again, and thus the branch merge at switch level at point “C” would not occur.

On the other hand, let's examine the possible drawback of choosing such a middle stage switch. As can be seen in another example shown in FIG. 6, if we choose middle stage switch MW₂, which has an existing connection with local multicast address LM₂={OW₃, OW₄}, the new connection yields the new local multicast address LM_{new,2}={OW₂, OW₃, OW₄}, and thus it would cause branch merges at switch level at oc₂ and oc₃ in output stage switch OW₂ later. Therefore, if we have multiple candidate middle stage switches that are in the existing multicast tree with the same root, the priority for the selection would be to select a middle stage switch that achieves

$${min}_{q} \vert {LM}_{new , q} - {LM}_{q} \vert \qquad ( 22 )$$

so that we can reduce the number of branch merges at switch level. Of course, in the above example, since MW₂ is the only such middle switch, we have to choose it.

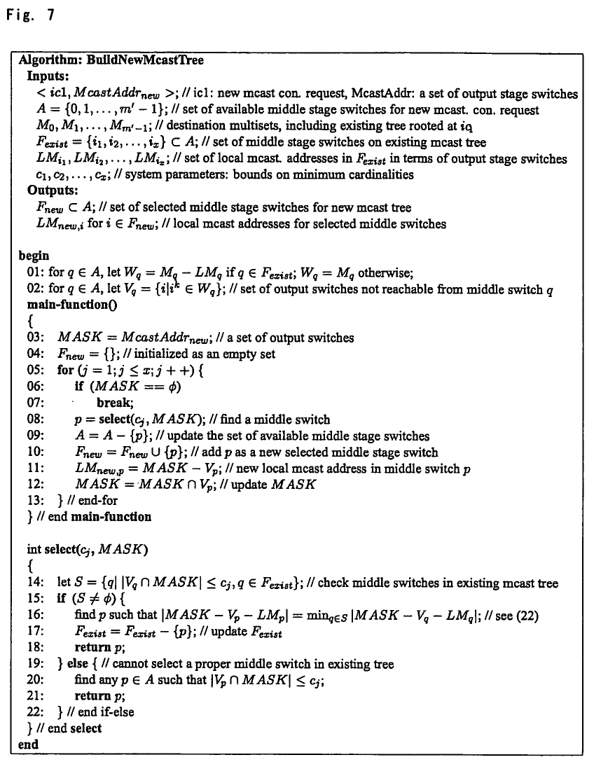

We now describe more detail on the routing algorithm. The detailed routing algorithm, called BuildNewMcastTree, is described in FIG. 7. The algorithm constructs a new multicast tree based on an existing multicast tree at the same root. The input to the algorithm is the new multicast connection request with McastAddr_{new}, in terms of a set of output stage switches, the set of available middle switches (including the middle stage switches of the existing multicast tree at the same root) for the new connection request, their destination multisets, the set of middle stage switches in the existing multicast tree, and the local multicast addresses of one-to-many connections in these middle stage switches in the existing multicast tree. The output of the algorithm is a set of selected middle stage switches for the new multicast tree, and the local multicast addresses of one-to-many connections in the selected middle stage switches in the new multicast tree.

Since we assume that the routing algorithm is for the non-trivial case, which implies that the number of middle stage switches for the existing multicast tree with the same root is already x, set Fₑₓᵢₛₜ is thus denoted as {i₁, i₂, . . . , iₓ}. In the initialization, W_{q} is defined as multiset M_{q}−LM_{q} (by using operation (21)) for qεFₑₓᵢₛₜ, or simply M_{q} for q∉Fₑₓᵢₛₜ; and V_{q} is defined as a set of output stage switches with no idle links from middle stage switch q. Thus, in the rest of the functions in the algorithm, only set operations (no multiset operations) are involved.

In the main function of the algorithm, set MASK is initially assigned McastAddr_{new}. It takes at most x iterations based on system parameters c₁, c₂, . . . , cₓ given earlier. In each iteration, it calls select(cⱼ, MASK) to choose a middle stage switch p for the new multicast tree (and stores p in F_{new}), then generates local multicast address LM_{new,p}, a set of output stage switches, of the one-to-many connection in middle stage switch p in the new tree, and finally updates variables MASK, etc.

In function select(cⱼ, MASK), it first checks whether there is any middle stage switch q in the existing multicast tree such that |Vₚ∩MASK|≦cⱼ. If there are multiple such switches, it returns the one with the minimum value as specified in (22). If no such a switch, it returns a middle stage switch p that satisfies |Vₚ∩MASK|≦cⱼ.

In what follows a description on the channel level implementation of the routing algorithm is made.

The algorithm outlined in the previous description generates a set of switches in the new multicast tree, and one-to-many connections at port level for each switch. In this section, we discuss how to implement the routing algorithm at channel level, i.e. how to identify and keep the shared branches (at channel level) of the existing tree and the new tree; how to identify and drop the branches that only belong to the existing tree; how to identify and add a branch (and how to assign a channel) that only belongs to the new tree; and how to change connections (drop and add simultaneously) in a switch that is on both existing and new trees. The implementation of adding and deleting routing algorithm in this section is actually to update switch routing tables so that the connections of the existing tree are changed to those of the new tree.

A routing table of a switch module, is a set of one-to-many connections in the form of (17). Since the switch information is known, a one-to-many connection can be expressed as

<ip₁, ic₁>→{<op₁, oc₁>, <op₂, oc₂>, <op_{f}, oc_{f}>} (23)

where ip₁ and opᵢ stand for the input port and output port of the switch, respectively, and ic₁ and ocᵢ stand for the input channel and output channel of the port, respectively. It should be pointed out that for connections of the existing tree, the channels are known, however, for those of the new tree, the channels are to be determined except for the input channel, and the output channels of the network specified in the new multicast connection request.

A description oh the identifying involved switches and the operations is made in what follows.

Let SWₑₓᵢₛₜ and SW_{new} are sets of switches of the existing tree and the new tree respectively. Clearly, for any switch in SWₑₓᵢₛₜ−SW_{new}, we need to perform a deletion operation only; for any switch in SW_{new}−SWₑₓᵢₛₜ, we need to perform an add operation only. However, for any switch in SW_{new ∩SW}ₑₓᵢₛₜ, the operations need to be performed depend on the connections in this switch for the existing tree and the new tree. We call this type of operations mixed operations and will discuss them in more detail in the following description on mixed operations.

For the switch that needs to perform a deletion operation only, it has one and only one one-to-many connection in the form of (23) for the existing tree. We can simply remove it from the routing table of this switch. An example of this case is MW₁ in FIG. 6.

For the switch that needs to perform an add operation only, it actually is part of the new tree. Thus we know the one-to-many connection at port level, but we need to determine the corresponding channels, i.e. (23) can be written as

<ip₁, ic₁(?)>→{<op₁, oc₁(?)>, <op₂, oc₂(?)>, . . . , <op_{f}, oc_{f}(?)>}

where “(?)” means that the channel number is to be determined. Clearly, if the switch is in the output stage, channel ocᵢ is determined by the detailed multicast address of the new multicast connection request; otherwise, channel ocᵢ of the corresponding output port of the switch can be assigned any idle channel on this port (the idle channel must exist based on the algorithm in the last section). The remaining is to determine channel ic₁. If this switch is in the input stage, ic₁ must be the input channel of the connection request. Otherwise, we can trace back on the new tree to the previous stage. In fact, by using (18), we can find the switch number and output port number of the previous stage, which are unique in the new multicast tree and the channel has been determined earlier. Thus, by using (18) again, we can let ic₁ be the channel in the previous stage. Examples of this case are MW₃ and OW₅ in FIG. 6.

In what follows a description on mixed operations is made.

The switch is on both the existing tree and the new tree. We need to find the difference of their one-to-many connections in this switch on the two trees. As indicated by Theorem 4, in general, the one-to-many connections of the existing tree and the new tree at port level share an input port of the switch, and thus we can let channel ic₁ of the new tree be the same as the existing tree (to avoid branch merges at channel level); only in an output stage switch, the two one-to-many connections may have different input ports on this switch. We have following different cases depending on the relationship between the new subtree and the existing subtree in the switch. Note that in the following descriptions for several cases concerning the new subtree and the existing subtrees, the one-to-many connections of the existing tree and the new tree share the same input port on the switch, while in the following description for the case in which new subtree and the existing subtree do not share an input port of the switch, the one-to-many connections use two different input ports on the switch.

The case in which the new subtree equals to the existing subtree is described below. That is, in the case, the one-to-many connections of this switch for the existing tree and the new tree are the same (at port level for the switch in the input stage or middle stage, and at output channel level for the switch in the output stage). The one-to-many connections (at channel level) of this switch for the existing tree can be used by the new tree directly. Thus nothing needs to be done. Examples of this case are OW₃ and OW₄ in FIG. 6.

The case in which the new subtree C the existing subtree is described below. That is, in this case, the one-to-many connections of the existing tree and the new tree at port level share an input port of the switch, but the local multicast address of the new tree is only a subset of the local multicast address of the existing tree. Therefore, we change the one-to-many connection (23) of the routing table for the existing tree by simply drop the unwanted local multicast address for the new tree. For example, if <op₁, oc₁>, <op₂, oc₂> are not in the new tree, the connection (23) is modified to

<ip₁,ic₁>→{<op₃,oc₃>, . . . , <op_{f},oc_{f}>}

in the routing table.

The case in which the new subtree⊃existing subtree is described below. That is, in this case, the one-to-many connections of the existing tree and the new tree at port level share an input port of the switch, but the local multicast address of the new tree is a superset of the local multicast address of the existing tree. We simply add some local multicast address to (23). It is similar to the above description, but here we do not need to determine ic₁, as it is already in use. An example of this case is MW₂ in FIG. 6.

The other cases in which the new subtree # the existing subtree are described below. That is, in these cases again the one-to-many connections of the existing tree and the new tree at port level share an input port of the switch, but there are some <opᵢ, ocᵢ(?)> in the new tree that are not in the existing tree, and some <opⱼ, ocⱼ> in the existing tree that are not in the new tree. We can modify the local multicast address in (23) to that for the new tree. An example of this case is IW₁ in FIG. 6. We may also have the special case of no shared branch in this switch for the two trees.

The description on the case in which the new Subtree and the existing subtree are not sharing an input port of the switch is made below.

In this case, the one-to-many connections of the existing tree and the new tree use different input ports of the switch. It is a branch merge at switch level, and occurs only in the output stage switch as stated in Theorem 4. What we need to do in the routing table is to drop the one-to-many connection for the existing tree as in the above description, and simultaneously add the one-to-many connection for the new tree as in another above description. Examples of this case are OW₁ and OW₂ in FIG. 6.

What is claimed is:

1. A nonblocking multicast switching network comprising:
an input stage, said input stage having n₁r₁ input ports and r₁ input switches, each input switch having n₁ input ports, and each input port having k input channels where k≧2;
an output stage, said output stage having n₂r₂ output ports and r₂ switches, each output switch having n₂ output port, and each output port having k output channels;
a middle stage, said middle stage having m middle switches, each middle switch having at least one input port with at least k channels connected to each input switch, and at least one output port with at least k channels connected to each output switch,
where
$$m > ⌊ ( {n}_{1} - \frac{1}{k} ) x ⌋ + {m}_{refine}^{′}$$
and said middle stage always has x or fewer of said middle switches to form a channel connection between an input channel of an input port of an input switch and an idle output channel of an output port of an output switch,
wherein x satisfies 1≦x≦min{n₂−1, r₂} and realizes the minimum value of
$$\{ ⌊ ( {n}_{1} - \frac{1}{k} ) x ⌋ + ( {n}_{2} - 1 ) {r}_{2}^{\frac{1}{x}} \}$$
and
m′_{refine} is calculated by the steps of
a step of substituting
$$⌈ ( {n}_{2} - 1 ) {r}_{2}^{\frac{1}{x}} ⌉$$
to a variable mm′,
a step of substituting (n₂−1)r₂ to a variable N′,
a step of substituting 0 to x variables cc₁, cc₂, . . . , ccₓ, and
a step of executing the following substeps while ccₓ equals to 0;
a substep of substituting
$$⌊ \frac{{N}^{′}}{{mm}^{′}} ⌋$$
to cc₁,
a substep of substituting
$$⌊ \frac{( {n}_{2} - 1 ) * {cc}_{i - 1}}{{mm}^{′}} ⌋$$
to ccᵢ for each i from 2 to x,
a substep of substituting the value of mm′ to m′_{refine} when ccₓ equals to 0, and
a substep of subtracting mm′ by 1.
